(19) United States
(12) Patent Application Publication
(10) Pub. No.: US 2025/0110769 A1
(43) Pub. Date: Apr. 3, 2025

(54) AUTOMATIC PROXY SETTINGS FOR CONTAINERIZED WORKLOADS

(71) Applicant: Dell Products, L.P., Round Rock, TX (US)

(72) Inventor: Michael Marrotte, Marrotte, FL (US)

(21) Appl. No.: 18/479,987

(22) Filed: Oct. 3, 2023

(51) Int. Cl. G06F 9/455

(52) U.S. Cl. CPC G06F 9/45558; G06F 2009/4557

(57) ABSTRACT

Architectures and techniques are described that can automatically determine proxy variable settings for a containerized workload for a given deployment environment of the containerized workload. Typically, a build pipeline of a container orchestration platform can build a containerized workload from received source code and deploys the containerized workload to a runtime environment. The disclosed techniques can, in response to a build being triggered, scan the source code and generate container images for HTTP requests. Once found, proxy variables can be determined and automatically injected into the container specifications.

### BACKGROUND

Containers can be thought of as packages of software that contain all of the necessary elements to run in any environment. In this way, containers effectively virtualize the operating system and run anywhere, from a private data center to the public cloud or even on a developer's personal laptop. As such, containers can be developed and deployed across many different environments without substantial code changes or the like. Container orchestration platforms such as Kubernetes and others exist to help developers of containerized workloads.

### BRIEF DESCRIPTION OF THE DRAWINGS

Numerous aspects, embodiments, objects, and advantages of the present embodiments will be apparent upon consideration of the following detailed description, taken in conjunction with the accompanying drawings, in which like reference characters refer to like parts throughout, and in which:

FIG. 1 depicts a schematic block diagram illustrating an example interaction with a container orchestration platform in accordance with certain embodiments of this disclosure;

FIG. 2 depicts a schematic block diagram illustrating a portion of a container orchestration platform with an automated proxy device that can automatically update the specification of a containerized workload with correct proxy settings in accordance with certain embodiments of this disclosure;

FIG. 3 depicts a call flow diagram illustrating example call flows for automatically determining proxy settings for a container workload in accordance with certain embodiments of this disclosure;

FIG. 4 depicts a schematic block diagram illustrating an example device that can provide automated and/or machine-generated proxy settings for a containerized workload in accordance with certain embodiments of this disclosure;

FIG. 5 depicts a schematic block diagram illustrating additional aspects or elements for automatically generating proxy settings for a containerized workload in accordance with certain embodiments of this disclosure;

FIG. 6A depicts a schematic block diagram 600A illustrating various examples of proxy variable settings in accordance with certain embodiments of this disclosure;

FIG. 6B depicts a schematic block diagram 600B illustrating various examples of a containerized workload in accordance with certain embodiments of this disclosure;

FIG. 7 illustrates an example method that can provide automated and/or machine-generated proxy settings for a containerized workload in accordance with certain embodiments of this disclosure;

FIG. 8 illustrates an example method that can provide for additional aspect or elements in connection with providing automated and/or machine-generated proxy settings for a containerized workload in accordance with certain embodiments of this disclosure;

FIG. 9 illustrates a block diagram of an example distributed file storage system that employs tiered cloud storage in accordance with certain embodiments of this disclosure; and

FIG. 10 illustrates an example block diagram of a computer operable to execute certain embodiments of this disclosure.

### DETAILED DESCRIPTION

### Overview

The disclosed subject matter is now described with reference to the drawings, wherein like reference numerals are used to refer to like elements throughout. In the following description, for purposes of explanation, numerous specific details are set forth in order to provide a thorough understanding of the disclosed subject matter. It may be evident, however, that the disclosed subject matter may be practiced without these specific details. In other instances, well-known structures and devices are shown in block diagram form in order to facilitate describing the disclosed subject matter.

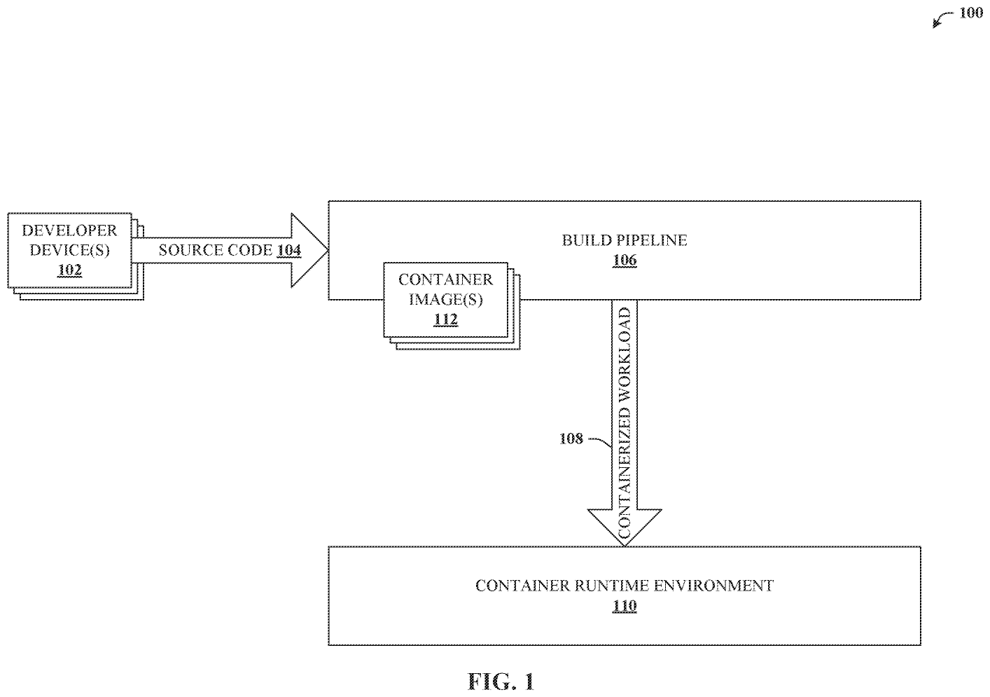

To better explain the disclosed techniques, it can be instructive to consider a relevant portion of an example containerized orchestration platform. FIG. 1 depicts a schematic block diagram 100 illustrating an example interaction with a container orchestration platform in accordance with certain embodiments of this disclosure. Developers of containerized workloads, such as containerized microservices or the like, often rely on a containerized orchestration platform to develop these containerized workloads. Typically, one or more developer will submit via developer device(s) 102 source code 104 to build pipeline 106 of the container orchestration platform.

In some embodiments, receipt of source code 104 can trigger a build. In other embodiments, after source code 104 is committed to build pipeline 106, source code 104 can be first reviewed by other developers before triggering the build. In either case, once a build is triggered, build pipeline 106, can build containerized workload 108 from source code 104. Such can include compiling, linking, packaging or other suitable operations to construct containerized workload 108, which can be deployed to a container runtime environment 110 for execution.

During the build process, build pipeline 106 can generate various intermediate files or data objects as well as one or more container images 112, which can be uploaded to an image server. In some embodiments, container image 112 can be substantially similar to Docker images or other suitable image. For example, a Docker image can be a read-only template containing a set of instructions for creating a container that can run on an associated platform. The image (e.g., container image 112) can provide a convenient way to package up applications and preconfigured server environments.

While using a container orchestration platform can simplify and automate many of the routine tasks of developers, and while utilizing containerized workloads 108 can simplify running containerized workloads 108 in many different environments, certain challenges remain. For example, containerized workloads 108 often make calls to other applications or services. The containerized workload may be deployed in an environment that utilizes a proxy server and the other applications or services to which the call is made may themselves be running behind proxies. Depending on the environment or business rules of a host, certain calls may require a proxy while other calls do not. From the developer perspective, the developer knows when a containerized workload 108 needs to make a call, but doesn't necessarily know whether a proxy will be used in a given deployment environment.

Containerized workloads 108 can be deployed to many different environments, each with potentially different proxy setting requirements, which places a difficult burden on developers. Failure to configure proxy settings correctly in a manner consistent with the deployment environment can result in performance issues, failed deployments, security risks, and so forth. However, correctly configuring proxy setting for containerized workload 108 is time-consuming, prone to errors, and often not well understood by certain developers that tend to focus on the function of containerized workload 108.

Proxy variables can be operating system variable. For example, in typical operating systems, proxy variables can be set up by configuring proxy variables such as HTTP_PROXY, HTTPS_PROXY, and/or NO_PROXY.

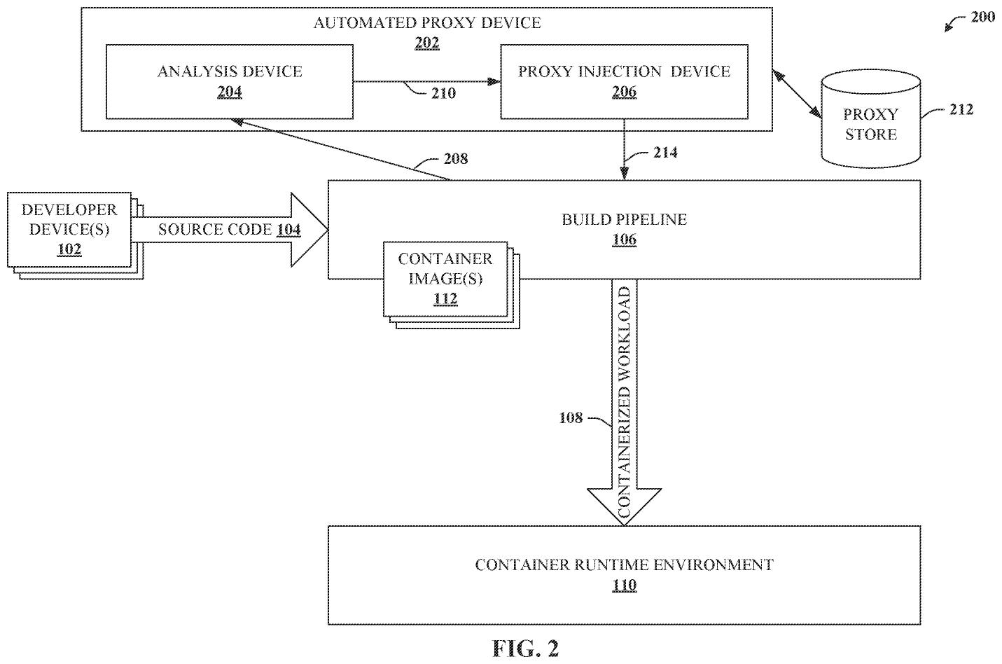

Historically, manual intervention is required to set various proxy variables, which is not scalable for large deployments. Hence, the disclosed subject matter, in some embodiments, is directed to automatically generating proxy settings for containerized workloads such as containerized workload 108, which is further detailed in connection with FIG. 2.

### Example Systems

Turning now to FIG. 2, a schematic block diagram 200 is depicted illustrating a portion of a container orchestration platform with an automated proxy device that can automatically update the specification of a containerized workload with correct proxy settings in accordance with certain embodiments of this disclosure.

For example, once source code 104 is received by build pipeline 106 and a build is triggered, source code 104 and container images 112 can be provided to automated proxy device 202, as illustrated by reference numeral 208. In this example, automated proxy device 202 comprises analysis device 204 and proxy injection device 206, but other arrangements are contemplated.

Analysis device 204 can be configured to scan or parse source code 104 and container images 112 in order to identify hypertext transfer protocol (HTTP) requests or calls. For example, an HTTP request can be a uniform resource identifier (URI), a uniform resource locator (URL), or another suitable call or request to a different application, service, resource, or the like.

Upon identification of an HTTP request, analysis device 204 and/or automated proxy device 202 can search proxy store 212 for pairs that require proxy variables. Proxy store 212 can be a database or store of known endpoints and deployment target pairs, which can be specific to a particular deployment environment and can be based on business rules or policies that can vary according to the particular deployment environment. For example, one deployment environment may not require a proxy for a particular HTTP request, while another deployment environment does. Hence, in the former case a NO_PROXY variable can be retrieved, while in the latter case, an HTTP_PROXY or HTTPS_PROXY variable can be received.

If a pair is returned from proxy store 212 to automated proxy device 202, then proxy injection device 206 can inject the correct proxy variables into the container specifications of containerized workload 108. Thus, build pipeline 106 can deploy containerized workload 108 with the appropriate settings into container runtime environment 110.

Such techniques relating to automatically injecting proxy variables into container specs based on code scans can significantly reduce the risk of incorrect configurations or other errors. Such can enable faster and more reliable deployment of containerized workloads 108, while reducing the burden on IT teams and developers. The disclosed techniques can provide an innovative approach to proxy configuration, having greater flexibility and scalability compared to other solutions and/or manual configuration.

In some embodiments, all or a portion of automated proxy device 202 can be integrated into build pipeline 106, integrated into another suitable portion of a container orchestration platform, or be or standalone device that communicates with build pipeline 106.

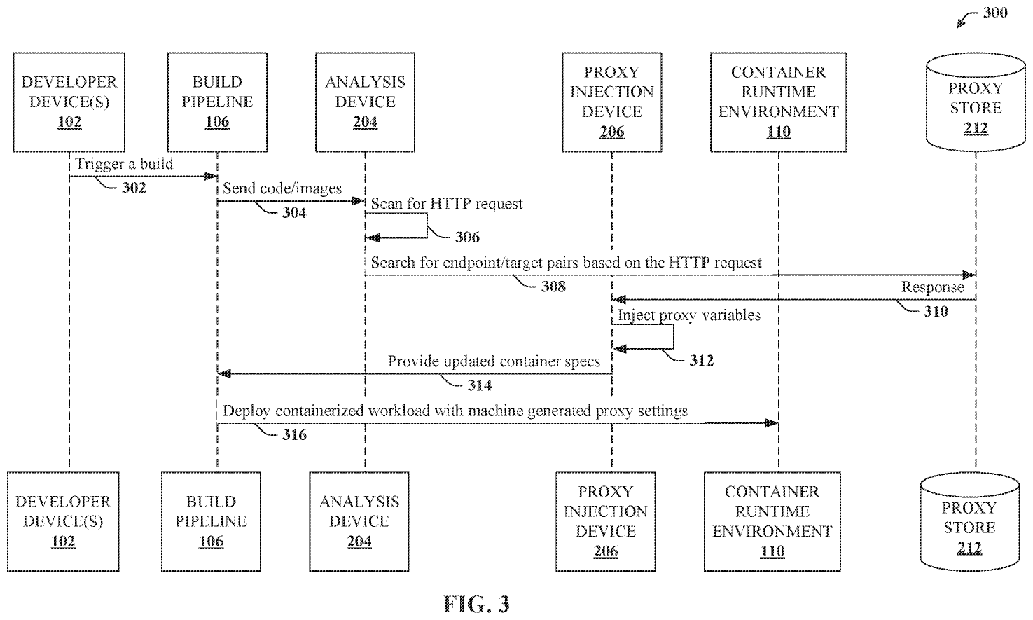

Referring now to FIG. 3, a call flow diagram 300 is depicted illustrating example call flows for automatically determining proxy settings for a container workload in accordance with certain embodiments of this disclosure. At reference numeral 302, developer device 102 can trigger a build. Such can be accomplished by submitting source code 104 or by approving previously submitted source code 104.

In response, build pipeline 106 can initiate a build process and, as indicated by reference numeral 304, transmit source code 104 and container images 112 to analysis device 204. Analysis device 204 can scan the received items for HTTP requests, as indicated at reference numeral 306. For each HTTP request identified, at reference numeral 308, analysis component can search for endpoint and deployment target pairs within proxy store 212.

At reference numeral 310, proxy injection device 206 can receive a response from proxy store 212, which can include any pairs identified in proxy store 212. At reference numeral 312, proxy injection device 206 can inject the correct proxy variables into the associated container specs.

At reference numeral 314, proxy injection device 206 can provide updated container specs to build pipeline 106. At reference numeral 316, build pipeline 106 can deploy the containerized workload with machine generated proxy setting to container runtime environment 110.

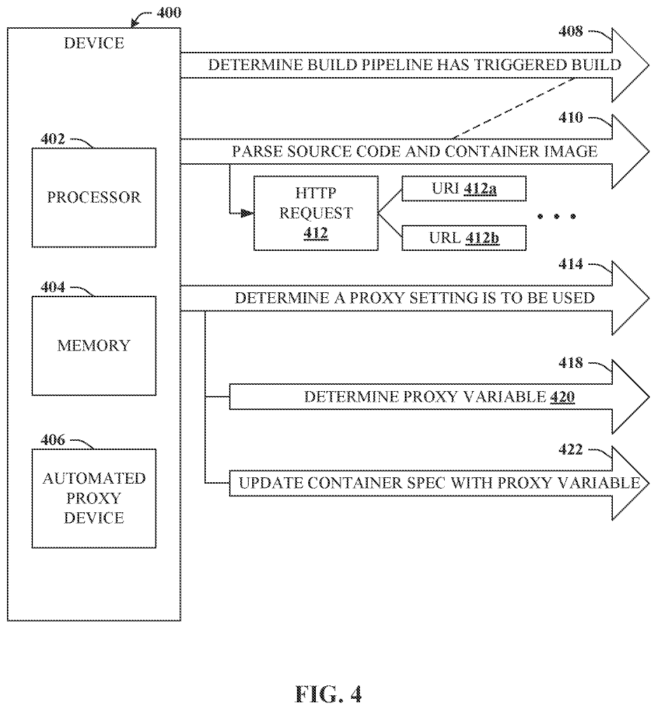

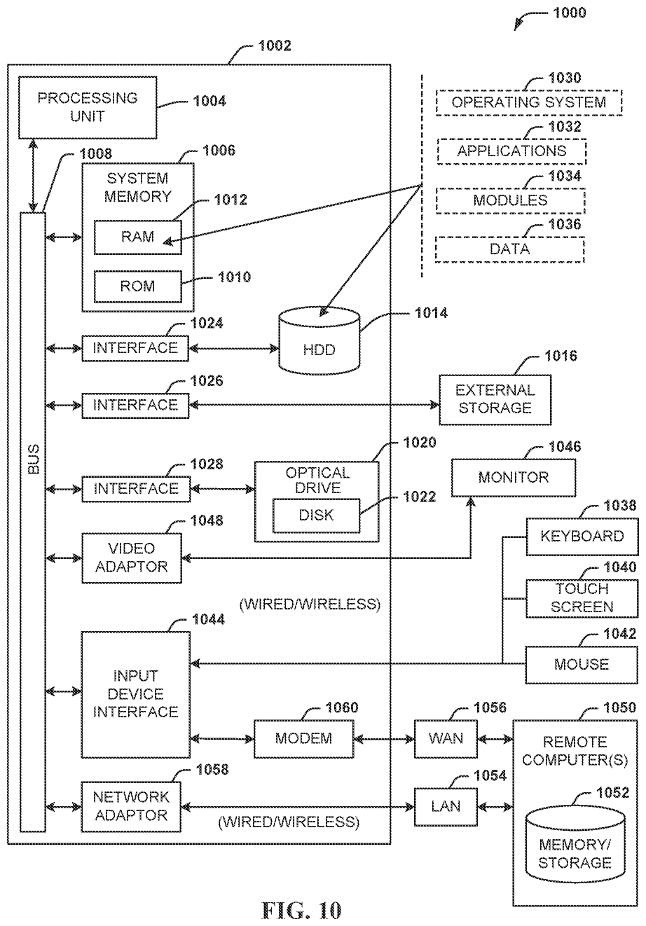

With reference now to FIG. 4, a schematic block diagram is depicted illustrating an example device 400 that can provide automated and/or machine-generated proxy settings for a containerized workload in accordance with certain embodiments of this disclosure. Device 400 can comprise a processor 402 that, potentially along with automated proxy device 406, can be specifically configured to perform functions associated with automatically generating proxy settings based on a deployment environment. Device 400 can also comprise memory 404 that stores executable instructions that, when executed by processor 402, can facilitate performance of operations. Processor 402 can be a hardware processor having structural elements known to exist in connection with processing units or circuits, with various operations of processor 402 being represented by functional elements shown in the drawings herein that can require special-purpose instructions, for example, stored in memory 404 and/or automated proxy device 406. Along with these special-purpose instructions, processor 402 and/or automated proxy device 406 can be a special-purpose device. Further examples of the memory 404 and processor 402 can be found with reference to FIG. 10. It is to be appreciated that device 400 or computer 1002 can represent a server device or a client device of a network or network services platform and can be used in connection with implementing one or more of the systems, devices, or components shown and described in connection with FIG. 4 and other figures disclosed herein.

In some embodiments, device 400 can be, or can be included in or communicatively coupled to, a container orchestration platform such as Kubernetes or the like. For example, device 400 can be integrated with or communicatively coupled to a build pipeline.

At reference numeral 408, device 400 can determine that a build pipeline (e.g., build pipeline 106) has triggered a build. The build can be triggered via receipt of source code, approval of received source code, or another suitable manner. Once triggered, the build pipeline can compile, link, and package the source code into a containerized workload that is further detailed below. As part of the build process, the build pipeline can generate a container image associated with the source code and/or the containerized workload.

In response to the building being triggered, device 400 can receive the source code and the container image. Hence, at reference numeral 410, device 400 can parse the source code and the container image to identify HTTP request 412. As previously noted, HTTP request 412 can be in the form of a URI 412a, a URL 412b, or another suitable form.

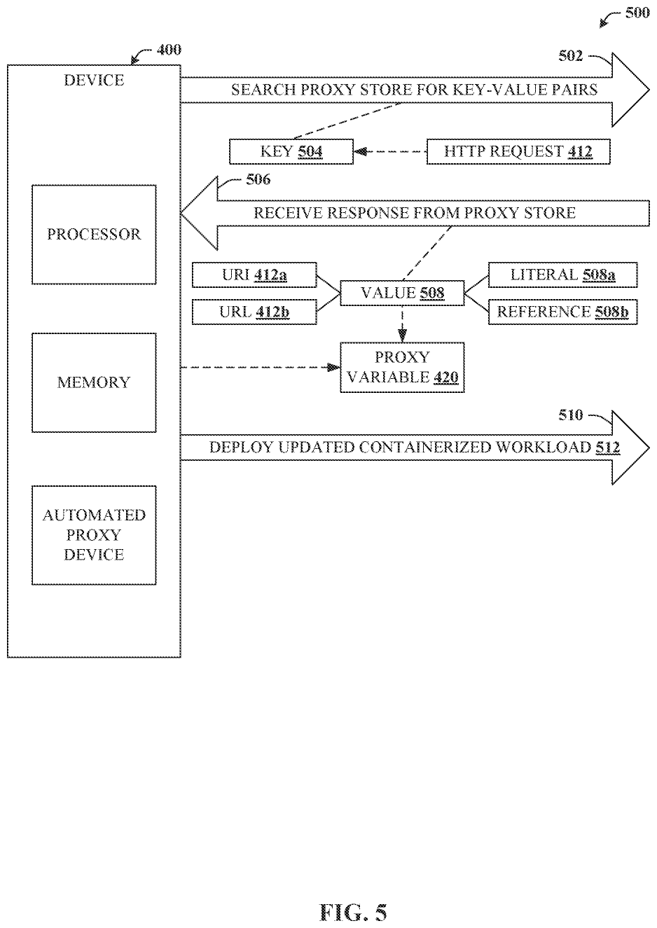

At reference numeral 414, device 400 can determine a proxy setting is to be used for HTTP request 412, which is further detailed in connection with FIG. 5. In response to said determination, at reference numeral 418, device 400 can determine proxy variable 420, which can be based on the business rules or policies of the deployment environment. At reference numeral 422, device 400 can update a container specification for the containerized workload to include the proxy variable 420.

Turning now to FIG. 5, a schematic block diagram 500 is depicted illustrating additional aspects or elements for automatically generating proxy settings for a containerized workload in accordance with certain embodiments of this disclosure.

As indicated at reference numeral 414 of FIG. 4, device 400 can determine that a proxy setting can be used. Such can be facilitated via access to proxy store 212. For instance, at reference numeral 502, device 400 can search a proxy store (e.g., proxy store 212) for key-value pairs. In other words, proxy store 212 can be configured as a key-value store. In this example, HTTP request 412 (e.g., a call to a service performed by the containerized workload) can comprise key 504. As one example, key 504 can represent a domain associated with the service that was called.

At reference numeral 506, proxy store 212 can respond with an associated value 508 that is paired with that particular key 504. Both key 504 and value 508 can be a URI 412a, a URL 412b, or another suitable format. For instance, in the event a proxy is to be used for the call, then value 508 can be a URL associated with the specified proxy server.

To provide a concrete example, suppose device 400 parses source code 104 and/or container images and identifies a call to a service at “mydomain.com”. Thus, key 504 can be populated with “mydomain.com” and that key 504 can be checked against proxy store 212. If a proxy is configured for that particular domain, then value 508 can comprise an address for the proxy service, for instance, “proxy.example.com”. If no value is returned, then such can mean that no proxy is configured for that particular domain. Once the key-value pair is returned, device 400 can construct the appropriate proxy variable 420.

For example, as previously noted, proxy variable 420 can be an operating system variable that defines whether or not a proxy is to be used. It is noted that these variable can include port numbers, username and password, and other suitable data.

Leveraging the previous example, an example HTTP_PROXY setting may look like the following:

export HTTP_PROXY=http://proxy.example.com:8080
export HTTPS_PROXY=http://proxy.example.com:8080

The above settings can instruct an environment to route both HTTP and HTTPS traffic through the proxy server at proxy.example.com on port 8080. Thus, in the event that value 508 comprises information relating to proxy.example.com:8080, similar code can be injected into container specs to automatically set the proxy variable.

export
HTTP_PROXY=http://username:password@proxy.example.com:8080
export
HTTPS_PROXY=http://username:password@proxy.example.com:8080

The above settings illustrate an example in which username and password are also provided.

On the other hand, if it is determined that no proxy is required for the call to mydomain.com, the NO_PROXY variable can be updated.
export NO_PROXY=localhost,127.0.0.1, *.mydomain.com,192.168.1.0/24,10.0.0.0/8

The above settings can instruct an environment not to use a proxy for the indicated endpoints including: localhost and 127.0.0.1 (which are generally the IP addresses of a local machine), any URL ending in mydomain.com, any IP address in the range of 192.168.1.0 to 192.168.1.255, and any IP address in the range of 10.0.0.0 to 10.255.255.255.

It is to be appreciated that 508a can be a literal value 508a (e.g., “proxy.example.com:8080”) in some embodiments, or a reference 508b in other embodiments. For example, reference 508b can be a reference to an application programming interface (API) object or another suitable element. One example can be the ConfigMap object of Kubernetes platforms, which is typically utilized to store data in a key-value pair format. Such can be employed to dynamically store the proxy values for each environment. When containers are deployed, the requested values can be extracted either directly as literals 508a or as references to ConfigMap. Such can provide for a practical adaptation to evolving deployment environments.

Hence, the disclosed subject matter can provide for a seamless blend of static and dynamic elements during the proxy injection process. For instance, at build time, proxy variables 420 can be assigned based on each target environment's specific conditions. As noted, this assignment can be a literal value (e.g., literal 508a) or a reference (e.g., reference 508b) to a dynamically maintained system, which highlights the adaptability of the disclosed techniques.

It can be observed that the disclosed techniques provide the capacity for efficient proxy value assignment, irrespective of whether assignment occurs at build time or deployment time. The flexibility in handling different types of assignment and the adaptability to deployment dynamics can demonstrate significant utility such as automatic identification of HTTP requests requiring proxy setting, dynamic assignment of proxy variables based on environment, and potential usage of tools like Kubernetes ConfigMap. These and other aspect can contribute to reducing incorrectly configured proxy settings (e.g., overwrite an incorrectly specified proxy variable 420) and can facilitate a more reliable deployment of containerized workloads.

However, in some instances, a particular developer may specifically want to have total control over proxy variable. To allow for that potential case, a mechanism can be provided to override or block the proxy injection aspects detailed herein. For example, this mechanism can be an annotation in source code 104 or another suitable technique.

Once proxy variable 420 is determined, at reference numeral 510, device 400 can deploy containerized workload 512, which has been updated with the indicated proxy variables/settings to the target environment.

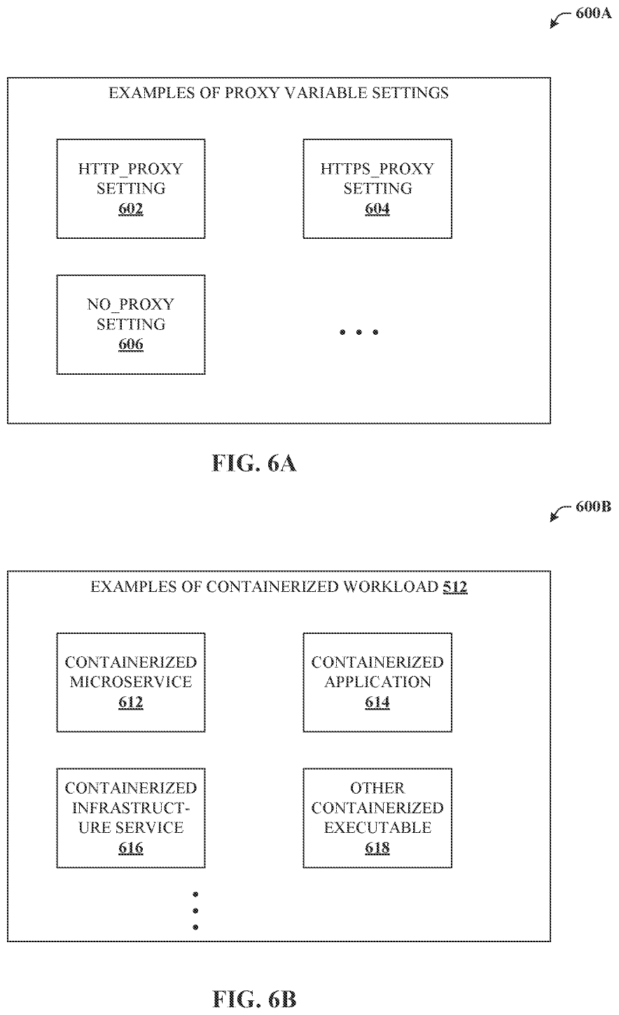

With regard to proxy variable 420, FIG. 6A depicts a schematic block diagram 600A illustrating various examples of proxy variable settings in accordance with certain embodiments of this disclosure. For instance, proxy variable 420 can relate to an HTTP_PROXY setting 602. Such can be applicable for typical HTTP traffic. As another example, proxy variable 420 can relate to an HTTPS_PROXY setting 604, which can relate to secure HTTP traffic.

Furthermore, proxy variable 420 can relate to a NO_PROXY setting 606, which can indicate traffic that is not to be routed through a proxy. Even though this traffic is not routed through the proxy server, correctly configuring the NO_PROXY setting 606 can be relied upon to properly route traffic in those cases. While the above are provided as non-limiting examples, it is appreciated that other examples can exist.

With regard to containerized workload 512, FIG. 6B depicts a schematic block diagram 600B illustrating various examples of a containerized workload in accordance with certain embodiments of this disclosure. For instance, containerized workload 512 can relate to a containerized microservice 612, a containerized application 614, a containerized infrastructure service 616, or any other suitable containerized executable 618.

### Example Methods

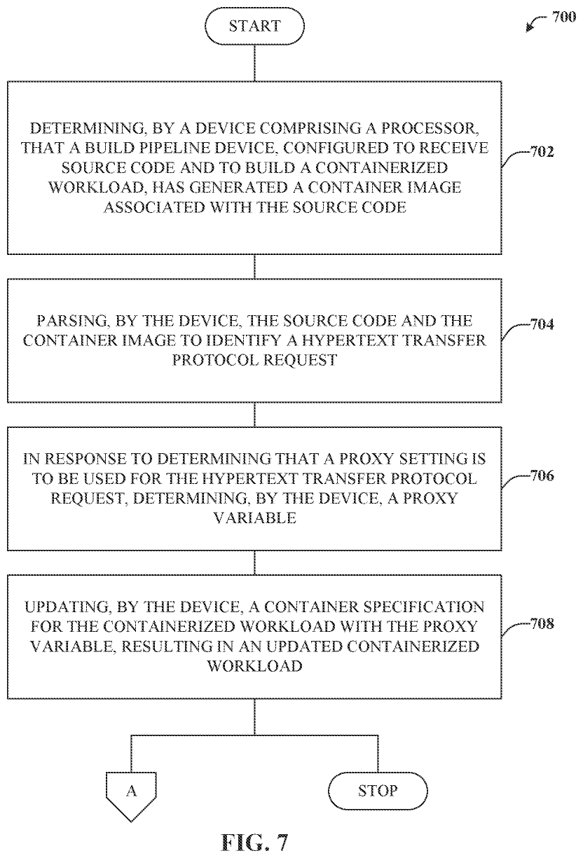

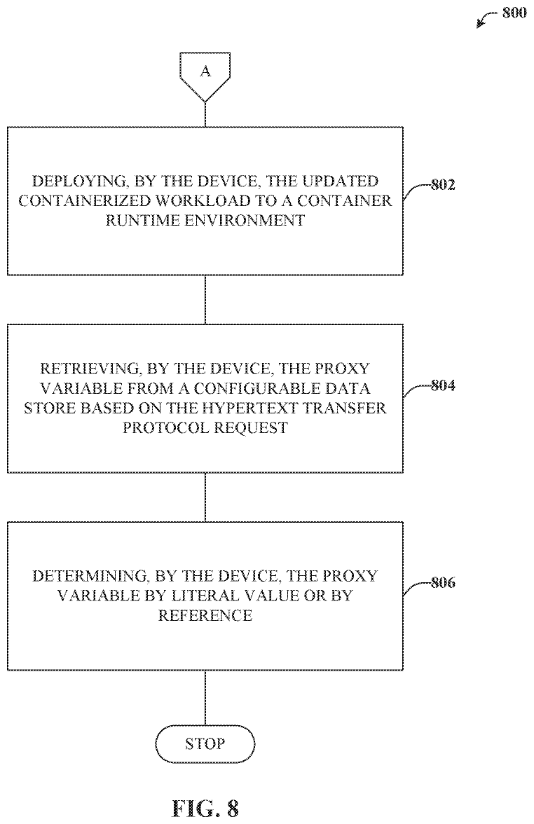

FIGS. 7 and 8 illustrate various methods in accordance with the disclosed subject matter. While, for purposes of simplicity of explanation, the methods are shown and described as a series of acts, it is to be understood and appreciated that the disclosed subject matter is not limited by the order of acts, as some acts may occur in different orders and/or concurrently with other acts from that shown and described herein. For example, those skilled in the art will understand and appreciate that a method could alternatively be represented as a series of interrelated states or events, such as in a state diagram. Moreover, not all illustrated acts may be required to implement a method in accordance with the disclosed subject matter. Additionally, it should be further appreciated that the methods disclosed hereinafter and throughout this specification are capable of being stored in an article of manufacture to facilitate transporting and transferring such methods to computers.

Referring now to FIG. 7, exemplary method 700 is depicted. Method 700 can provide automated and/or machine-generated proxy settings for a containerized workload in accordance with certain embodiments of this disclosure. While method 700 describes a complete method, in some embodiments, method 700 can include one or more elements of method 800, as illustrated by insert A.

At reference numeral 702, a device comprising a processor can determine that a build pipeline device has generated a container image associated with the source code. The build pipeline device can be a part of a container orchestration platform and can be configured to receive source code and to build a containerized workload from that source code. In some embodiments, the container image can be uploaded to an image server.

At reference numeral 704, the device can parse the source code and the container image to identify a hypertext transfer protocol request. In some embodiments, the hypertext transfer protocol request can represent a call to a service or resource that is performed by the containerized workload. In some embodiments, the hypertext transfer protocol request can be in the form of a URI, a URI, or another suitable form.

At reference numeral 706, in response to determining that a proxy setting is to be used for the hypertext transfer protocol request, determining, by the device, a proxy variable. In some embodiments, the proxy variable can be an operating system variable that defines various proxy settings to be employed in connection with the hypertext transfer protocol request and/or other communication by the containerized workload.

At reference numeral 708, the device can update a container specification for the containerized workload with the proxy variable. Such can result in an updated containerized workload and/or an updated container specification. Method 700 can terminate or, in some embodiments, proceed to insert A, which is further detailed in connection with FIG. 8.

Turning now to FIG. 8, exemplary method 800 is depicted. Method 800 can provide for additional aspect or elements in connection with providing automated and/or machine-generated proxy settings for a containerized workload in accordance with certain embodiments of this disclosure.

At reference numeral 802, the device introduced at reference numeral 702 comprising a processor can deploy the updated containerized workload to a container runtime environment. For example, the updated containerized workload can utilize the updated proxy variables that can be suitable for the deployment environment.

At reference numeral 804, the device can retrieve the proxy variable from a configurable data store based on the hypertext transfer protocol request. The configurable data store can be a dynamically updated key-value pair data store such that a search for a given key can return the key-value pair as results.

At reference numeral 806, the device can determine the proxy variable by literal value or by reference. In other words, the results returned can be a literal value or a reference to an API object such as Kubernetes ConfigMap.

### Example Operating Environments

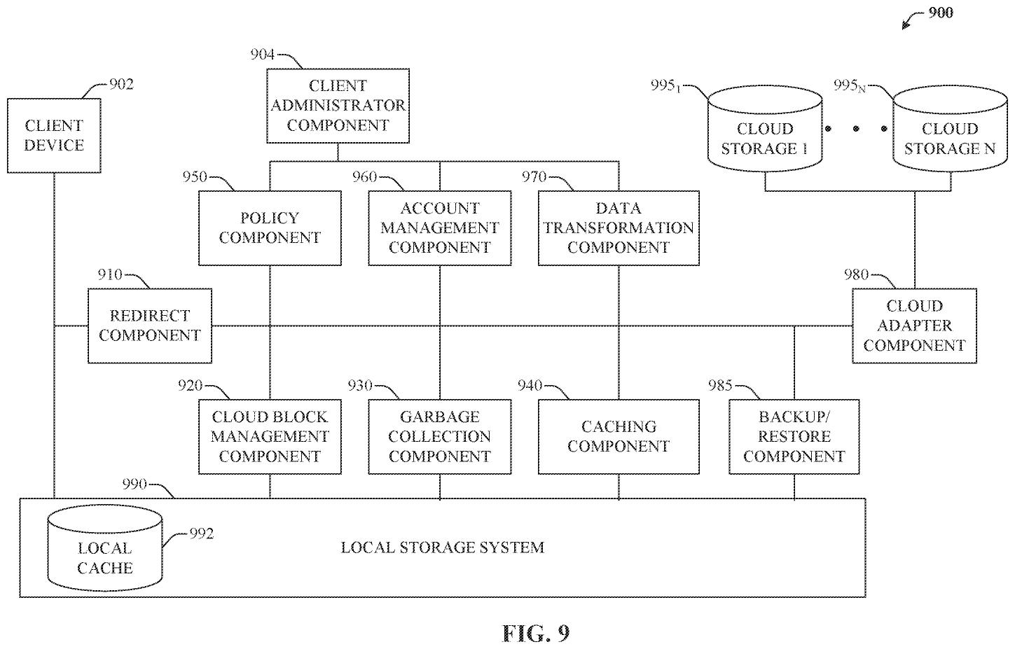

To provide further context for various aspects of the subject specification, FIGS. 9 and 10 illustrate, respectively, a block diagram of an example distributed file storage system 900 that employs tiered cloud storage and block diagram of a computer 1002 operable to execute the disclosed storage architecture in accordance with aspects described herein.

Referring now to FIG. 9, there is illustrated an example local storage system including cloud tiering components and a cloud storage location in accordance with implementations of this disclosure. Client device 902 can access local storage system 990. Local storage system 990 can be a node and cluster storage system such as an EMC Isilon Cluster that operates under OneFS operating system. Local storage system 990 can also store the local cache 992 for access by other components. It can be appreciated that the systems and methods described herein can run in tandem with other local storage systems as well.

As more fully described below with respect to redirect component 910, redirect component 910 can intercept operations directed to stub files. Cloud block management component 920, garbage collection component 930, and caching component 940 may also be in communication with local storage system 990 directly as depicted in FIG. 9 or through redirect component 910. A client administrator component 904 may use an interface to access the policy component 950 and the account management component 960 for operations as more fully described below with respect to these components. Data transformation component 970 can operate to provide encryption and compression to files tiered to cloud storage. Cloud adapter component 980 can be in communication with cloud storage 1 995₁ and cloud storage N 995_{N}, where N is a positive integer. It can be appreciated that multiple cloud storage locations can be used for storage including multiple accounts within a single cloud storage location as more fully described in implementations of this disclosure. Further, a backup/restore component 985 can be utilized to back up the files stored within the local storage system 990.

Cloud block management component 920 manages the mapping between stub files and cloud objects, the allocation of cloud objects for stubbing, and locating cloud objects for recall and/or reads and writes. It can be appreciated that as file content data is moved to cloud storage, metadata relating to the file, for example, the complete inode and extended attributes of the file, still are stored locally, as a stub. In one implementation, metadata relating to the file can also be stored in cloud storage for use, for example, in a disaster recovery scenario.

Mapping between a stub file and a set of cloud objects models the link between a local file (e.g., a file location, offset, range, etc.) and a set of cloud objects where individual cloud objects can be defined by at least an account, a container, and an object identifier. The mapping information (e.g., mapinfo) can be stored as an extended attribute directly in the file. It can be appreciated that in some operating system environments, the extended attribute field can have size limitations. For example, in one implementation, the extended attribute for a file is 8 kilobytes. In one implementation, when the mapping information grows larger than the extended attribute field provides, overflow mapping information can be stored in a separate system b-tree. For example, when a stub file is modified in different parts of the file, and the changes are written back in different times, the mapping associated with the file may grow. It can be appreciated that having to reference a set of non-sequential cloud objects that have individual mapping information rather than referencing a set of sequential cloud objects, can increase the size of the mapping information stored. In one implementation, the use of the overflow system b-tree can limit the use of the overflow to large stub files that are modified in different regions of the file.

File content can be mapped by the cloud block management component 920 in chunks of data. A uniform chunk size can be selected where all files that are tiered to cloud storage can be broken down into chunks and stored as individual cloud objects per chunk. It can be appreciated that a large chunk size can reduce the number of objects used to represent a file in cloud storage; however, a large chunk size can decrease the performance of random writes.

The account management component 960 manages the information for cloud storage accounts. Account information can be populated manually via a user interface provided to a user or administrator of the system. Each account can be associated with account details such as an account name, a cloud storage provider, a uniform resource locator (“URL”), an access key, a creation date, statistics associated with usage of the account, an account capacity, and an amount of available capacity. Statistics associated with usage of the account can be updated by the cloud block management component 920 based on list of mappings it manages. For example, each stub can be associated with an account, and the cloud block management component 920 can aggregate information from a set of stubs associated with the same account. Other example statistics that can be maintained include the number of recalls, the number of writes, the number of modifications, and the largest recall by read and write operations, etc. In one implementation, multiple accounts can exist for a single cloud service provider, each with unique account names and access codes.

The cloud adapter component 980 manages the sending and receiving of data to and from the cloud service providers. The cloud adapter component 980 can utilize a set of APIs. For example, each cloud service provider may have provider specific API to interact with the provider.

A policy component 950 enables a set of policies that aid a user of the system to identify files eligible for being tiered to cloud storage. A policy can use criteria such as file name, file path, file size, file attributes including user generated file attributes, last modified time, last access time, last status change, and file ownership. It can be appreciated that other file attributes not given as examples can be used to establish tiering policies, including custom attributes specifically designed for such purpose. In one implementation, a policy can be established based on a file being greater than a file size threshold and the last access time being greater than a time threshold.

In one implementation, a policy can specify the following criteria: stubbing criteria, cloud account priorities, encryption options, compression options, caching and IO access pattern recognition, and retention settings. For example, user selected retention policies can be honored by garbage collection component 930. In another example, caching policies such as those that direct the amount of data cached for a stub (e.g., full vs. partial cache), a cache expiration period (e.g., a time period where after expiration, data in the cache is no longer valid), a write back settle time (e.g., a time period of delay for further operations on a cache region to guarantee any previous writebacks to cloud storage have settled prior to modifying data in the local cache), a delayed invalidation period (e.g., a time period specifying a delay until a cached region is invalidated thus retaining data for backup or emergency retention), a garbage collection retention period, backup retention periods including short term and long term retention periods, etc.

A garbage collection component 930 can be used to determine which files/objects/data constructs remaining in both local storage and cloud storage can be deleted. In one implementation, the resources to be managed for garbage collection include CMOs, cloud data objects (CDOs) (e.g., a cloud object containing the actual tiered content data), local cache data, and cache state information.

A caching component 940 can be used to facilitate efficient caching of data to help reduce the bandwidth cost of repeated reads and writes to the same portion (e.g., chunk or sub-chunk) of a stubbed file, can increase the performance of the write operation, and can increase performance of read operations to portion of a stubbed file accessed repeatedly. As stated above with regards to the cloud block management component 920, files that are tiered are split into chunks and in some implementations, sub chunks. Thus, a stub file or a secondary data structure can be maintained to store states of each chunk or sub-chunk of a stubbed file. States (e.g., stored in the stub as cacheinfo) can include a cached data state meaning that an exact copy of the data in cloud storage is stored in local cache storage, a non-cached state meaning that the data for a chunk or over a range of chunks and/or sub chunks is not cached and therefore the data has to be obtained from the cloud storage provider, a modified state or dirty state meaning that the data in the range has been modified, but the modified data has not yet been synched to cloud storage, a sync-in-progress state that indicates that the dirty data within the cache is in the process of being synced back to the cloud and a truncated state meaning that the data in the range has been explicitly truncated by a user. In one implementation, a fully cached state can be flagged in the stub associated with the file signifying that all data associated with the stub is present in local storage. This flag can occur outside the cache tracking tree in the stub file (e.g., stored in the stub file as cacheinfo), and can allow, in one example, reads to be directly served locally without looking to the cache tracking tree.

The caching component 940 can be used to perform at least the following seven operations: cache initialization, cache destruction, removing cached data, adding existing file information to the cache, adding new file information to the cache, reading information from the cache, updating existing file information to the cache, and truncating the cache due to a file operation. It can be appreciated that besides the initialization and destruction of the cache, the remaining five operations can be represented by four basic file system operations: Fill, Write, Clear and Sync. For example, removing cached data is represented by clear, adding existing file information to the cache by fill, adding new information to the cache by write, reading information from the cache by read following a fill, updating existing file information to the cache by fill followed by a write, and truncating cache due to file operation by sync and then a partial clear.

In one implementation, the caching component 940 can track any operations performed on the cache. For example, any operation touching the cache can be added to a queue prior to the corresponding operation being performed on the cache. For example, before a fill operation, an entry is placed on an invalidate queue as the file and/or regions of the file will be transitioning from an uncached state to cached state. In another example, before a write operation, an entry is placed on a synchronization list as the file and/or regions of the file will be transitioning from cached to cached-dirty. A flag can be associated with the file and/or regions of the file to show that it has been placed in a queue and the flag can be cleared upon successfully completing the queue process.

In one implementation, a time stamp can be utilized for an operation along with a custom settle time depending on the operations. The settle time can instruct the system how long to wait before allowing a second operation on a file and/or file region. For example, if the file is written to cache and a write back entry is also received, by using settle times, the write back can be re-queued rather than processed if the operation is attempted to be performed prior to the expiration of the settle time.

In one implementation, a cache tracking file can be generated and associated with a stub file at the time it is tiered to the cloud. The cache tracking file can track locks on the entire file and/or regions of the file and the cache state of regions of the file. In one implementation, the cache tracking file is stored in an Alternate Data Stream (“ADS”). It can be appreciated that ADS are based on the New Technology File System (“NTFS”) ADS. In one implementation, the cache tracking tree tracks file regions of the stub file, cached states associated with regions of the stub file, a set of cache flags, a version, a file size, a region size, a data offset, a last region, and a range map.

In one implementation, a cache fill operation can be processed by the following steps: (1) an exclusive lock on can be activated on the cache tracking tree; (2) it can be verified whether the regions to be filled are dirty; (3) the exclusive lock on the cache tracking tree can be downgraded to a shared lock; (4) a shared lock can be activated for the cache region; (5) data can be read from the cloud into the cache region; (6) update the cache state for the cache region to cached; and (7) locks can be released.

In one implementation, a cache read operation can be processed by the following steps: (1) a shared lock on the cache tracking tree can be activated; (2) a shared lock on the cache region for the read can be activated; (3) the cache tracking tree can be used to verify that the cache state for the cache region is not “not cached;” (4) data can be read from the cache region; (5) the shared lock on the cache region can be deactivated; (6) the shared lock on the cache tracking tree can be deactivated.

In one implementation, a cache write operation can be processed by the following steps: (1) an exclusive lock on can be activated on the cache tracking tree; (2) the file can be added to the synch queue; (3) if the file size of the write is greater than the current file size, the cache range for the file can be extended; (4) the exclusive lock on the cache tracking tree can be downgraded to a shared lock; (5) an exclusive lock can be activated on the cache region; (6) if the cache tracking tree marks the cache region as “not cached” the region can be filled; (7) the cache tracking tree can updated to mark the cache region as dirty; (8) the data can be written to the cache region; (9) the lock can be deactivated.

In one implementation, data can be cached at the time of a first read. For example, if the state associated with the data range called for in a read operation is non-cached, then this would be deemed a first read, and the data can be retrieved from the cloud storage provider and stored into local cache. In one implementation, a policy can be established for populating the cache with range of data based on how frequently the data range is read; thus, increasing the likelihood that a read request will be associated with a data range in a cached data state. It can be appreciated that limits on the size of the cache, and the amount of data in the cache can be limiting factors in the amount of data populated in the cache via policy.

A data transformation component 970 can encrypt and/or compress data that is tiered to cloud storage. In relation to encryption, it can be appreciated that when data is stored in off-premises cloud storage and/or public cloud storage, users can require data encryption to ensure data is not disclosed to an illegitimate third party. In one implementation, data can be encrypted locally before storing/writing the data to cloud storage.

In one implementation, the backup/restore component 985 can transfer a copy of the files within the local storage system 990 to another cluster (e.g., target cluster). Further, the backup/restore component 985 can manage synchronization between the local storage system 990 and the other cluster, such that, the other cluster is timely updated with new and/or modified content within the local storage system 990.

In order to provide additional context for various embodiments described herein, FIG. 10 and the following discussion are intended to provide a brief, general description of a suitable computing environment 1000 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments of the aspects described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and an optical disk drive 1020 (e.g., which can read or write from a CD-ROM disc, a DVD, a BD, etc.). While the internal HDD 1014 is illustrated as located within the computer 1002, the internal HDD 1014 can also be configured for external use in a suitable chassis (not shown). Additionally, while not shown in environment 1000, a solid state drive (SSD) could be used in addition to, or in place of, an HDD 1014. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 1094 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are example and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 1102.11 (a, b, g, n, etc.) to provide secure, reliable, fast wireless connectivity. A Wi-Fi network can be used to connect computers to each other, to the Internet, and to wired networks (which use IEEE802.3 or Ethernet). Wi-Fi networks operate in the unlicensed 5 GHz radio band at a 54 Mbps (802.11a) data rate, and/or a 2.4 GHz radio band at an 11 Mbps (802.11b), a 54 Mbps (802.11g) data rate, or up to a 600 Mbps (802.11n) data rate for example, or with products that contain both bands (dual band), so the networks can provide real-world performance similar to the basic “10BaseT” wired Ethernet networks used in many offices.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. In an aspect, when a processor executes instructions to perform “operations”, this could include the processor performing the operations directly and/or facilitating, directing, or cooperating with another device or component to perform the operations.

In the subject specification, terms such as “data store,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated aspects of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or API components.

Further, the various embodiments can be implemented as a method, apparatus, or article of manufacture using standard programming and/or engineering techniques to produce software, firmware, hardware, or any combination thereof to control a computer to implement one or more aspects of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A device, comprising:
a processor; and
a memory that stores executable instructions that, when executed by the processor, facilitate performance of operations, comprising:
determining that a build pipeline device, configured to receive source code and build a containerized workload, has generated a container image associated with the source code;
parsing the source code and the container image to identify a hypertext transfer protocol request;
in response to determining that a proxy setting is to be used for the hypertext transfer protocol request, determining a proxy variable; and
updating a container specification for the containerized workload to include the proxy variable.

2. The device of claim 1, wherein the updating of the container specification results in an updated containerized workload comprising machine generated proxy settings, and wherein the updated containerized workload is deployed to a container runtime environment.

3. The device of claim 1, wherein the containerized workload is at least one of a containerized microservice, a containerized application, or a containerized infrastructure service.

4. The device of claim 1, wherein the hypertext transfer protocol request comprises a uniform resource identifier or a uniform resource locator.

5. The device of claim 1, wherein the hypertext transfer protocol request represents a call to service that is performed by the containerized workload.

6. The device of claim 1, wherein the proxy variable represents a setting for one or more HTTP_PROXY settings, one or more HTTPS_PROXY settings, or one or more NO_PROXY settings.

7. The device of claim 1, wherein the proxy variable comprises a uniform resource identifier or a uniform resource locator of a proxy server or a domain associated with the hypertext transfer protocol request.

8. The device of claim 1, wherein a value of the proxy variable is stored at a known endpoint and deployment target pair data store that is configurable based on a deployment environment.

9. The device of claim 8, wherein the value of the proxy variable is stored as a key-value pair that is paired with a domain of the hypertext transfer protocol request.

10. The device of claim 8, wherein the value of the proxy variable is stored as a reference to an API object.

11. The device of claim 1, wherein the updating of the container specification comprises inserting the proxy variable or overwriting an incorrectly specified proxy variable.

12. A non-transitory computer-readable medium comprising instructions that, in response to execution, cause a system comprising a processor to perform operations, comprising:
determining that a build pipeline device, comprising a capability to receive source code and to build a containerized workload, has generated a container image associated with the source code;
scanning the source code and the container image to identify a hypertext transfer protocol request;
retrieving, from a key-value pair data store, key-value pairs that indicate proxy setting variables; and
updating a container specification for the containerized workload to include the proxy setting variables.

13. The non-transitory computer-readable medium of claim 12, wherein the proxy setting variable presents a setting for at least one of an HTTP_PROXY setting, an HTTPS_PROXY setting, or a NO_PROXY setting.

14. The non-transitory computer-readable medium of claim 12, wherein the containerized workload is at least one of a containerized microservice, a containerized application, or a containerized infrastructure service.

15. The non-transitory computer-readable medium of claim 12, wherein the hypertext transfer protocol request comprises a uniform resource identifier or a uniform resource locator.

16. The non-transitory computer-readable medium of claim 12, wherein a value of the proxy variable is stored at a known endpoint and deployment target pair data store that is configurable based on a deployment environment.

17. A method, comprising:
determining, by a device comprising a processor, that a build pipeline device, configured to receive source code and to build a containerized workload, has generated a container image associated with the source code;
parsing, by the device, the source code and the container image to identify a hypertext transfer protocol request;
in response to determining that a proxy setting is to be used for the hypertext transfer protocol request, determining, by the device, a proxy variable; and
updating, by the device, a container specification for the containerized workload with the proxy variable, resulting in an updated containerized workload.

18. The method of claim 17, further comprising deploying, by the device, the updated containerized workload to a container runtime environment.

19. The method of claim 17, further comprising retrieving, by the device, the proxy variable from a configurable data store based on the hypertext transfer protocol request.

20. The method of claim 17, further comprising determining, by the device, the proxy variable by literal value or by reference.
